(19) United States
(12) Patent Application Publication
(10) Pub. No.: US 2022/0019871 A1
(43) Pub. Date: Jan. 20, 2022

(54) Method for Adapting a Software Application Executed in a Gateway

(71) Applicant: Siemens Aktiengesellschaft, Muenchen (DE)

(72) Inventor: Daniel SCHALL, Hollabrunn (AT)

(21) Appl. No.: 17/312,982

(22) PCT Filed: Dec. 4, 2019
(86) PCT No.: PCT/EP2019/083616

§ 371 Date: Jun. 11, 2021

(30) Foreign Application Priority Data
Dec. 12, 2018 (EP) 18211831.5

(51) Int. Cl. G06N 3/04; G06N 3/08; H04L 29/08; H04L 12/46; G06N 20/00

(52) U.S. Cl. CPC G06N 3/04; G06N 3/08; H04L 67/2828; G06N 20/00; H04L 67/34; H04L 12/46; H04L 67/2842

(57) ABSTRACT

A method for adapting a first software application that is executed in a gateway G and that controls the data transfer of the gateway, wherein in the gateway connects at least one device of a local network to a cloud network, where machine learning is performed via a second software application based on at least one state of the environment of the gateway and at least one possible action of the gateway, the result of the machine learning contains at least one quality value of a pairing of a state of the environment of the gateway and an action of the gateway, and where the first software application executes those actions of the gateway that have a higher quality value for a given state of the environment of the gateway than other actions.

### CROSS-REFERENCE TO RELATED APPLICATIONS

This is a U.S. national stage of application No. PCT/EP2019/083616 filed 4 Dec. 2019. Priority is claimed on European Application No. 18211831.5 filed 12 Dec. 18 2018, the content of which is incorporated herein by reference in its entirety.

### BACKGROUND OF THE INVENTION

### 1. Field of the Invention

The present invention relates to a method for adapting a first software application that is executed in a gateway and controls the data transmission of the gateway, where the gateway connects at least one device of a local network to a cloud network, and where the invention is employed in particular in a conjunction with the Internet of Things (IoT).

### 2. Description of the Related Art

The Internet of Things (IoT) comprises a network of physical devices, such as sensors or actuators. The devices are provided with electronics, software and a network connection, which makes it possible for these devices to establish a connection and to exchange data. What are referred to as platforms make it possible for the user to connect their devices and physical data infrastructure, i.e., their local network, to the digital world, i.e., to a further network, as a rule what is referred to as a cloud network.

The cloud network can consist of a number of different cloud platforms, which are usually offered by different providers. A cloud platform makes available IT infrastructure, such as storage space, computing power or application software for example, as a service over the Internet. The local network inclusive of local computing resources is also referred to as the edge. Computing resources at the edge are especially suited to decentralized data processing.

The devices or their local network are or is typically connected by what are referred to as gateways to the cloud network, which comprises what is referred to as the back end and offers back-end services. A gateway is a hardware and/or software component, which establishes a connection between two networks. The data of the devices of the local network is now to be transmitted reliably via the gateway to the back-end services, where this is made more difficult by fluctuations in the bandwidth of the local network and fluctuations in the size and the transmission speed of the data. A static method of data transmission from the local network via the gateway into the cloud network does not normally take account of this.

Basically, there are various methods for how the devices of the IoT can be connected to one another or to the cloud network: from device to device, from device to cloud and from device to gateway. The present invention primarily relates to the method by which the device is connected to a gateway of the local network, but could also be applied to the other methods.

In the device-to-gateway method, one or more devices connect themselves via an intermediate device, i.e., the gateway, to the cloud network or to the cloud services, and also to the back-end services. Often the gateway uses its own application software for this. The gateway can additionally also provide other functionalities, such as a security application, or a translation of data and/or protocols. The application software can be an application that pairs with the device of the local network and establishes the connection to a cloud service.

The gateways mostly support a preprocessing of the data of the devices, which as a rule includes an aggregation or compression of data as well as a buffering of the data in order to be able to counteract interruptions of the connection to the back-end services. The management of complex operating states at the gateway, such as transmission of different types of data during batch transmission of files or the transmission of time-critical data, and of random fluctuations of the local network are not currently well supported.

There are concepts at the network level for improving the quality of service (QoS) of the network. However, these QoS concepts just operate at network level and not at the level of software applications. This means that the needs of the software applications cannot be addressed.

### SUMMARY OF THE INVENTION

It is thus an object of the invention to provide a method with which applications for data transmission, which are executed in a gateway, can adapt their behavior.

This and other objects and advantages are achieved in accordance with the invention by a method for adapting a first software application, which is executed on a gateway and which controls the data transmission of the gateway, where the gateway connecting at least one device of a local network to a cloud network, where machine learning based on at least one state of the environment of the gateway and also on at least one possible action of the gateway to be executed via a second software application occurs, the result of the machine learning contains at least one quality value of a pairing of state of the environment of the gateway and action of the gateway, and the first software application executes those actions of the gateway which, for a given state of the environment of the gateway, have a higher quality value than other actions.

The invention thus provides for machine learning to control a gateway function.

In an embodiment of the invention, the second software application comprises a confirmation learning method, where an acknowledgement occurs in the form of a reward for each pairing of status of the environment of the gateway and action of the gateway.

Reinforcement learning (RL), also referred to as confirmation learning, stands for a series of machine learning methods, in which an agent independently learns a strategy, in order to maximize rewards obtained. In such cases, the action that is the best in a particular situation is not shown to the agent in advance, but it receives a reward at specific points in time, which can also be negative. On the basis of these rewards, it approximates a benefit function, here a quality function (or quality values), which describes which value has a specific state or a specific action.

In particular, there can be provision for the second software application to comprise a method for Q learning.

In one embodiment of the invention, the data about the state of the environment of the gateway before the confirmation learning is grouped into clusters. This enables the confirmation learning to be simplified.

In another embodiment of the invention, the Q learning occurs with the aid of a model, which is trained on a cloud platform in the cloud network with the current data of the state of the environment of the gateway, and a trained model is made available to the gateway if required. This means that there is no additional load imposed on the gateway by the computations for the Q learning.

The model can comprise a neural network, of which the learning characteristics, such as learning speed, can be well defined using parameters.

In another embodiment of the invention, the first software application comprises a first controller, which does not take account of the result of the machine learning, and also a second controller, which does take account of the result of the machine learning, where the second controller is employed as soon as quality values are available from the machine learning, in particular as soon as a trained model, as described above, is available.

The inventive method is executed on or with one or more computers. Consequently, the invention also comprises a corresponding computer program product, which in turn comprises instructions which, when the program is executed by a gateway, cause the gateway to implement all steps of the inventive method. The computer program product can be a data medium for example, on which a corresponding computer program is stored, or it can be a signal or a data stream, which can be loaded via a data connection into the processor of a computer.

The computer program product can thus cause the following or perform them itself: machine learning based on at least one state of the environment of the gateway and also at least one possible action of the gateway is performed via a second software application, the result of the machine learning contains at least one quality value of a pairing of state of the environment of the gateway and action of the gateway, and the first software application executes those actions of the gateway that, for a given state of the environment of the gateway, have a higher quality value than other actions.

When the second software application is not executed in the gateway, the computer program will cause the second software application to be executed on another computer, such as on a cloud platform in the cloud network.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

To further explain the invention, reference is made in the following part of the description to the schematic figures, from which further advantageous details and possible areas of application of the invention can be inferred, in which:

FIG. 1 shows a schematic diagram of the functional principle of confirmation learning;

FIG. 2 shows a simplified model of the Internet of Things;

FIG. 3 shows a table with possible combinations of states of the environment of the gateway;

FIG. 4 shows a table with states of the environment of the gateway and possible actions of the gateway;

FIG. 5 shows a table with clustering of the data from FIG. 4;

FIG. 6 shows a neural network for confirmation learning in accordance with the invention;

FIG. 7 shows a possible simplex architecture for confirmation learning in accordance with the invention; and

FIG. 8 is a flowchart of the method in accordance with the invention.

### DETAILED DESCRIPTION OF THE EXEMPLARY EMBODIMENTS

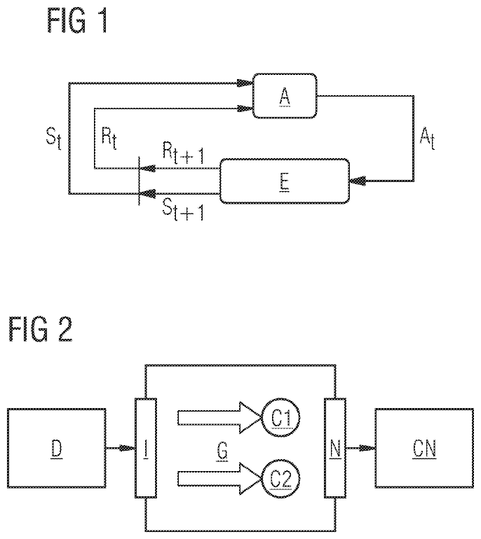

FIG. 1 shows the functional principle of confirmation learning. Confirmation learning is used here for controlling the behavior of the devices that are part of a local network and participate in the Internet of Things. S refers to a set of states of the environment E. A refers to a set of actions of an agent Ag. Pa(Sₜ, Sₜ₊₁) refers to the probability of the transition of the state from St to state Sₜ₊₁ while the agent Ag is performing the action Aₜ. Rₜ₊₁ refers to the direct reward after the transition from state Sₜ to state Sₜ₊₁ by the action Aₜ.

The gateway G now represents the agent A, which interacts with its environment E. The environment E comprises other devices that are connected to the gateway G and send over data at regular or irregular intervals, the network interface and the connectivity to the cloud-based back-end services. All these factors bring uncertainty with them and represent a challenge in relation to dealing with the workload and any performance restrictions or outages.

The set of states of the environment E contains, for example, the current state of the local network, the rate of data that is arriving at gateway G from neighboring devices of the local network, the types of data stream that are arriving at gateway G from neighboring devices of the local network, and/or state data of the agent Ag, i.e., of the gateway G, such as the load on the resources of the gateway G (CPU, memory, or queue) at that particular moment.

The set A of actions of agent Ag, i.e., of the gateway G, can comprise the following:
Receive data from a connected device
Add it to the queue
Reprioritize an element in the queue
Process a request
Compress data
Divide up data
Transform specific data
Store data in a buffer
Transmit data to a back-end service

The reward can be defined on the basis of specific metrics, where the metrics can comprise the following:
the average waiting time until an action of the gateway G
the length of the queue
the average slowing down of a job, with J=C/T, where C represents the processing time of the job (i.e., the time from entry of the job until the job is complete) and T represents the ideal duration of the job.

Shown in FIG. 2 is a simplified model of the Internet of Things. Here, only one device D of the local network is shown. The device D does not have a direct link to the cloud network CN but is connected to the gateway G and transmits data streams to said gateway via an input interface I. The gateway G has two processor units C1, C2, which can work in parallel. The gateway G is connected via an output interface N to the cloud network CN, e.g., to a specific cloud platform therein. The output interface N can be a wireless Internet access and therefore susceptible to fluctuations in the connection quality or in data throughput. The cloud platform receives data streams from the gateway G and thereby performs further actions, such as storage, analysis, visualization.

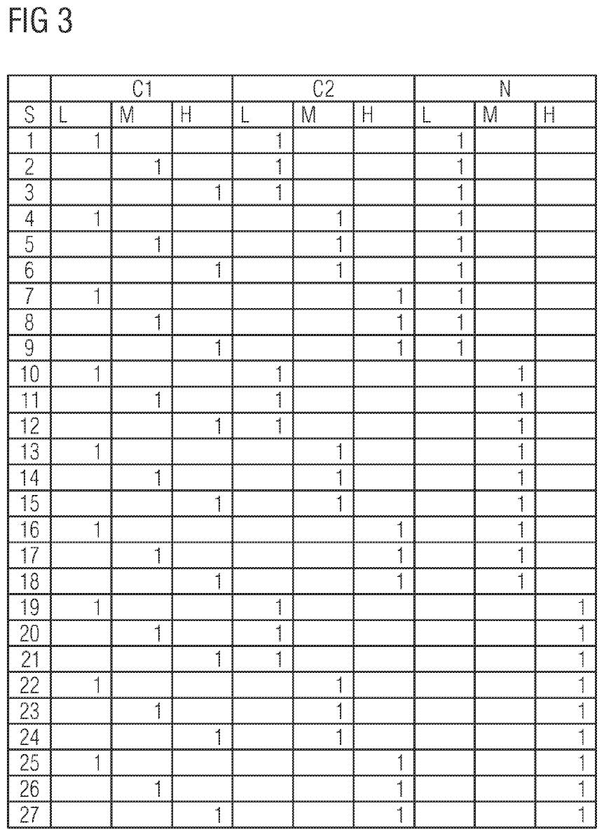

If one just concentrates on the significant components of input interface I and processor units C1, C2 in order to model the workload and the environment E of the gateway, and if one uses only three possible actual states, L low, M medium and H high, then there are 3³=27 states for the model, which are shown in the table of FIG. 3.

The Boolean value 1 represents the presence of a specific state. In order to now handle all possible states, rules must be established. Strict rules however, depending on the current state of the environment E, can also lead to non-optimal or undesired results. The disclosed embodiments of the present invention now make provision for specific actions to be derived from the current state and for the agent at the gateway G to learn autonomously over time what the best action is, in that a reward for the actions is given.

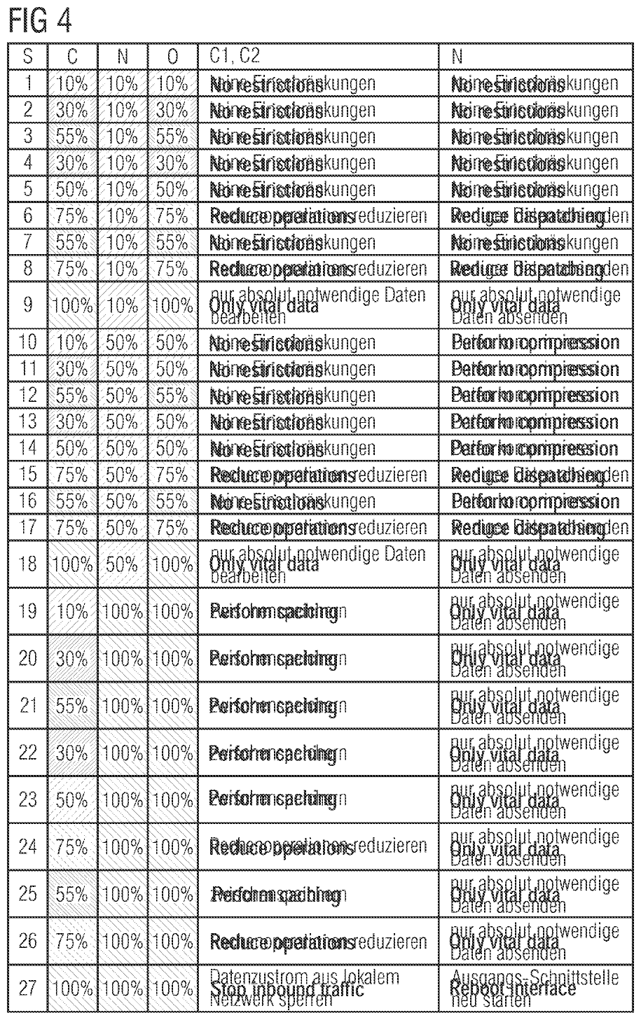

Shown in the table of FIG. 4 is a practical example for states and possible actions. An aggregation is performed to make the states of the device G (and of the local network more easily recognizable. For the processor units C1, C2, there is the aggregation to C as follows;

C=0.5*(value(C1,L)*0.1+value (C1,M)*0.5+value (C1,H)+0.5*(value(C2,L)*0.1+value (C2,M)*0.5+value (C2,H)

The function value(x,y) fetches the value 0 or 1 from the corresponding column of the table of FIG. 3. The overall state C of the processor units C1, C2 is a weighted sum of the individual states. The overall condition N of the network of the output interface N, to which the gateway G represents the interface, is derived in a similar way based on the possible states L low, M medium and H high.

The overall state O of the gateway G is derived as follows: O=MAX(C, N), thus the maximum from the entries in column C and column N is used.

The table in FIG. 4 shows by way of example that the agent Ag, i.e., the gateway G, starting from a specific state S, can derive actions A, which take account of the processing capacity and the data transmission to the back-end services. The value or the quality of this action A can be learned over time via the receiving of a reward. The following are provided as actions in FIG. 4 for the processor units C1, C2 (penultimate column) and for the output interface N:

No restrictions

Perform caching

Perform compression

Reduce operations

Reduce dispatching

Reboot interface

Only vital data

Stop inbound traffic

In order to determine the quality Q of a combination of a state S and an action A, what is referred to a Q learning is employed:

Q(Sₜ, Aₜ) is assigned to

(1-∞) Q ((Sₜ, Aₜ)+∞(Rₜ+Y maxₐ (Q (Sₜ₋₁, , a)))

Q(Sₜ, Aₜ) is the old value (at point in time t) of the quality for the value pair (Sₜ, Aₜ).

∞ is the learning rate with (0<∞<1).

Rₜ is the reward that is obtained for the current state Sₜ.

Y is a discount factor.

maxₐ (Sₜ₊₁, a) is the estimated value of an optimal future value of the quality (at point in time t+1), where a is an element of A, i.e., a single action from a set of actions A.

Finally, a Q function Q(Sₜ, Aₜ) is produced, dependent on various sets A, S of states and actions.

Shown in FIG. 5 is how data from FIG. 4 can be grouped (clustered), such as for computing the estimated value of an optimal future value of the quality. The k-means algorithm can be used as the method for clustering, for example, or hierarchical cluster methods. The formation of clusters, here cluster 1, . . . to cluster X, can be performed with the aid of similar values in the column N or also in the columns C and N.

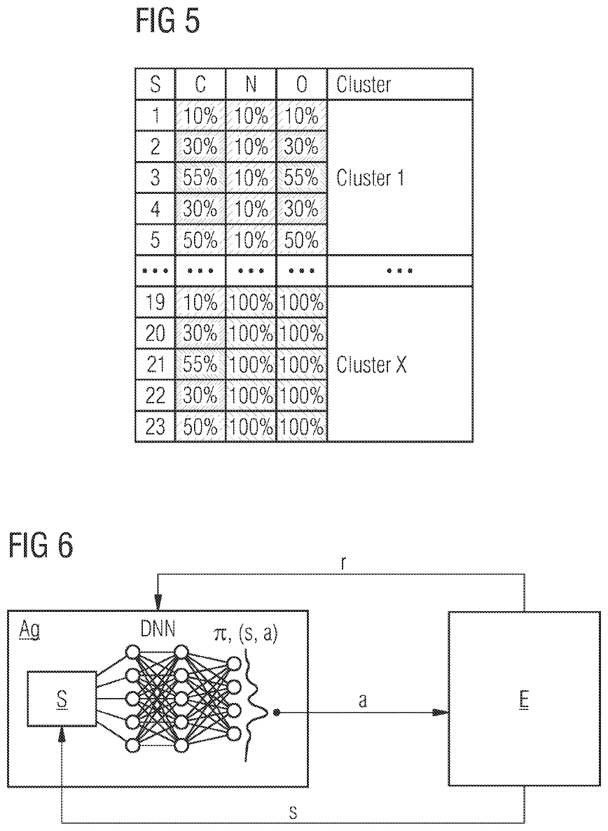

The quality specified above of a combination of a set S of states and a set A of actions would now have to be computed in real time by the gateway G, which is difficult in some cases as a result of the limited capacity of the hardware of the gateway G, of the actual workload of the gateway G to be dealt with and also the number of states to be taken into account. Instead, a function approximation can be performed, which is shown in FIG. 6 with the aid of a neural network.

What is referred to as a Deep Neural Network DNN is trained offline, i.e., outside the normal operation of the gateway G and then instantiated by the Agent Ag, i.e., by the gateway G, in the normal operation of the gateway G, so that the Deep Neural Network DNN consisting of a current state s of the environment E make a recommendation for an action a. This method is much faster and causes less computing effort at the gateway G. A recommendation can be created in the range of a few milliseconds.

During training of the Deep Neural Network DNN, which is done offline, i.e., not during operation of the Agent Ag as gateway G, the agent Ag selects an action a based on a random distribution IC, where IC is a function of an action a and a state s and applies for the function value: (0<π(s; a)≤1). The agent Ag performs this action a on the environment E. A status of the environment E is then observed by the agent AG as a result, read in and passed to the Deep Neural Network DNN. The reward r resulting from the action a is again supplied to the Deep Neural Network DNN, which finally learns via back-propagation which combinations of a specific state s and a specific action a produce the greatest possible reward r. The learning result results in a corresponding improved estimation of the quality, i.e., the Q function. The longer the agent Ag is trained with the help of the environment E, the better the estimated Q function from the back-propagation approximates to the true Q function.

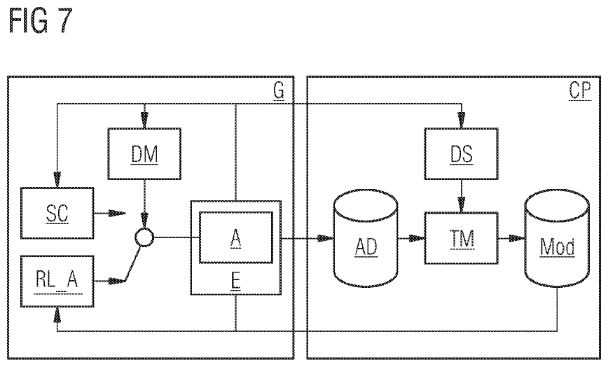

A possible architecture for the reinforcement learning using deep learning, thus a deep reinforcement learning, is shown in FIG. 7. Shown in the figure are the gateway G and a cloud platform CP of the cloud network CN (see FIG. 2). In this figure, a known so-called simplex system architecture known per se is used, which contains a standard controller SC and an advanced controller, which applies the confirmation learning and is therefore referred to as the RL agent RL_A. The standard controller SC determines the point in time that the data is dispatched and performs the dispatching, but without optimization. The RL agent RL_A applies methods for learning, just like the confirmation learning described above, in order to optimize the data transmission.

At the beginning, the gateway G operates with the standard controller SC. In a cloud platform CP, a so-called Device Shadow DS of the gateway G is provided, in which the model, such as the Deep Neural Network DNN from FIG. 6, is trained via a training model TM. In this case, the model is trained with the aid of actual data AD of the gateway G and with the aid of the actual configuration of the gateway G. The trained model is stored in a memory for models, referred to here as Mod and the RL agent RL_A is informed about the presence of a model. The RL agent RL_A loads the model from the memory Mod for models and the decision module DM of the gateway G has the option to switch from the standard controller SC to the RL agent RL_A in order in this way to improve the behavior of the gateway G in relation to data transmission.

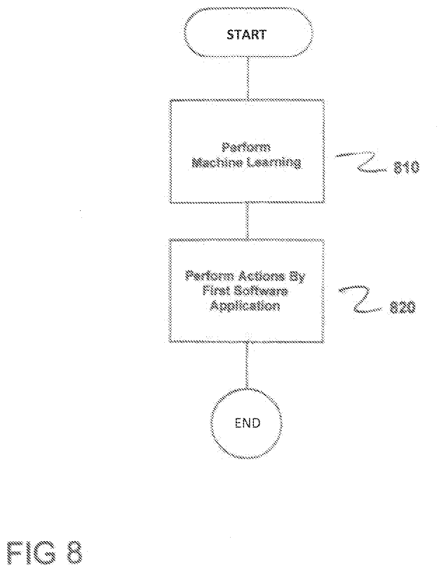

FIG. 8 is a flowchart of the method for adapting a first software application executed in a gateway G and controlling data transmission of the gateway, where the gateway connects at least one device D of a local network to a cloud network CN. The method comprises performing machine learning via a second software application based on at least one state s, S of an environment E of the gateway G and of at least one possible action a, A of the gateway G, as indicated in step 810. Here, the result of the machine learning contains at least one quality value of a pairing of state s, S of the environment of the gateway and action a, A of the gateway. Next, the first software application performs actions a, A of the gateway which, for a given state s, S of the environment of the gateway, have a higher quality value than other actions, as indicated in step 820.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-8. (canceled)

9. A method for adapting a first software application executed in a gateway and controlling data transmission of the gateway, said gateway connecting at least one device of a local network to a cloud network, the method comprising:
performing machine learning via a second software application based on at least one state of an environment of the gateway and of at least one possible action of the gateway, the result of the machine learning containing at least one quality value of a pairing of state of the environment of the gateway and action of the gateway; and
performing by the first software application actions of the gateway which, for a given state of the environment of the gateway, have a higher quality value than other actions.

10. The method as claimed in claim 9, wherein the second software application comprises a method for confirmation learning; and wherein an acknowledgement comprising a reward is provided for each pairing of state of the environment of the gateway and action of the gateway.

11. The method as claimed in claim 9, wherein the second software application comprises a method for Q learning.

12. The method as claimed in claim 10, wherein the second software application comprises a method for Q learning.

13. The method as claimed in claim 10, wherein the data about the state of the environment of the gateway is grouped into clusters before the reinforcement learning.

14. The method as claimed in claim 11, wherein the data about the state of the environment of the gateway is grouped into clusters before the reinforcement learning.

15. The method as claimed in claim 11, wherein the Q learning is performed aided by a model, which is trained on a cloud platform in the cloud network with the current data of the state of the environment of the gateway, and a trained model is made available to the gateway if required.

16. The method as claimed in claim 15, wherein the model comprises a neural network.

17. The method as claimed in claim 9, wherein the first software application comprises a first controller which does not take account of the result of the machine learning, and comprises a second controller which does take account of the result of the machine learning;
and wherein the second controller is employed as soon as quality values are available from the machine learning.

18. The method as claimed in claim 17, wherein the second controller is employed as soon as a model which is trained on a cloud platform in the cloud network with the current data of the state of the environment of the gateway is available.

19. A non-transitory computer-readable computer program product encoded with instruction which, when executed by a gateway, cause said gateway to connect at least one device of a local network to a cloud network, the program instructions comprising:
program code for performing machine learning via a second software application based on at least one state of an environment of the gateway and of at least one possible action of the gateway, the result of the machine learning containing at least one quality value of a pairing of state of the environment of the gateway and action of the gateway; and
program code for performing by the first software application actions of the gateway which, for a given state of the environment of the gateway, have a higher quality value than other actions.
